(19) United States
(12) Patent Application Publication
(10) Pub. No.: US 2012/0102145 A1
(43) Pub. Date: Apr. 26, 2012

(54) SERVER, USER TERMINAL APPARATUS AND METHOD OF CONTROLLING THE SAME, AND METHOD OF PROVIDING SERVICE

(75) Inventors: Hee-jae JUNG, Suwon-si (KR); Jung-hwan Kim, Seoul (KR); So-jin Kim, Suwon-si (KR); Yong-soo Jung, Gunpo-si (KR)

(73) Assignee: Samsung Electronics Co., Ltd., Suwon-si (KR)

(21) Appl. No.: 13/242,631

(22) Filed: Sep. 23, 2011

(30) Foreign Application Priority Data
Oct. 26, 2010 (KR) 10-2010-0104732

(51) Int. Cl. G06F 15/16

(52) U.S. Cl. 709/217

(57) ABSTRACT

A server, a user terminal and a method of providing service by uploading at least one content list generated by packaging a plurality of content, extracting a core content by considering a packaging frequency for each content included in the at least one content list; and recommending an extracted core content to a user if requested by a user.

### PRIORITY

This application claims priority under 35 U.S.C. §119 to Korean Patent Application No. 10-2010-0104732, which was filed in the Korean Intellectual Property Office on Oct. 26, 2010, the entire disclosure of which is incorporated herein by reference.

### BACKGROUND OF THE INVENTION

1. Field of the Invention

The present invention relates generally to a server, a user terminal apparatus and a method of controlling the same, and a method of providing service, and more particularly, to a server, a user terminal apparatus and a method of controlling the same, and a method of providing service which recommend content.

2. Description of the Related Art

With the development of content industries, it has become more important to select good content among the large number of content. Methods of recommending user-customized content, such as Demographic Filtering (DF), Collaborative Filtering (CF), Expert Based Filtering (EXP) have been widely used for music, smart phone applications, and the like.

DF is a method of recommending content for users having a similar profile using user profile information but the simple user profile makes it difficult to recommend user-customized content.

CF is a method of recommending user-based or item-based content but because the content is classified for each user or each item, the method has a cold-start problem.

EXP is a classic method of recommending content by an expert. EXP can reduce the number of wrong recommendations through direct recommendation by a person as compared to DF or CF, but this method is problematic in that there is a limit on the amount of recommendations.

The problems with finding recommended content are evident, for example, when finding applications to download.

One way to find a desired application is to search for it using a search function through key words. However, if a user does not know the exact application name, it is very difficult to find the desired application. Another way to find a desired application is for a user to browse an application list for each category or for each popular rank in an application store and download a desired application through that method, which provides the user with an advantage to download a higher ranked application. However, when the application is not popular or highly ranked it is difficult to find the desired application. Finally, it is also difficult to find a desired application even when application information is obtained through a community.

Further, in the related art, rating information for an application is obtained through a star rating of the application. However, it is disadvantageous in that the star rating is entered according to the subjective point of view of a user and because there is no incentive for a user to enter the star rating many users do not use the star rating. Therefore, there is a need for a new method for recommending content.

### SUMMARY OF THE INVENTION

Accordingly, the present invention has been made to solve the above-mentioned problems occurring in the prior art, and to provide at least the advantages as describe below. Accordingly, an aspect of the present invention provides a sever, a user terminal apparatus and a method of controlling the same, and a method of proving service which are capable of recommending novel content being hiding.

According to another aspect of the present invention, there is provided a method of providing service. The method includes at least one content list generated by packaging a plurality of content being uploaded; extracting a core content by considering a packaging frequency for each content included in the at least one content list; and recommending an extracted core content to a user if requested by a user.

According to another aspect of the present invention, there is provided a method of controlling a user terminal apparatus. The method includes downloading a plurality of content and storing usage data for each content; generating at least one content list by packaging a plurality of content of the plurality of content downloaded corresponding to a preset subject based on the usage data; and uploading the at least one content list generated to a server.

According to another aspect of the present invention, there is provided a server. The server includes a communication unit in which at least one content list generated by packaging a plurality of content is uploaded; an extraction unit which extracts a core content by considering a packaging frequency of each content included in the at least one content list; a recommendation unit which recommends a predetermined content to a user; and a control unit which controls to recommend the core content extracted from the extraction unit, requested by the user.

According to another aspect of the present invention, there is provided a user terminal apparatus. The user terminal apparatus includes a storage unit which stores a plurality of content downloaded and usage data for each content; a User Interface (UI) unit which provides an UI for selecting and packaging a plurality of content from the plurality of content downloaded; a packaging unit which packages the plurality of content and generates at least one content list for the plurality of content packaged; a communication unit which uploads the at least one content list generated to a server; and a control unit which controls to package the plurality of content selected through the UI among the plurality of content stored in the storage unit.

### BRIEF DESCRIPTION OF THE DRAWINGS

The above and/or other aspects features and advantages of the embodiments of the present invention will be more apparent from the following description, taken in conjunction with the accompanying drawings, in which:

FIG. 1 is a block diagram illustrating a configuration of a server according to an embodiment of the present invention;

FIG. 2 is a block diagram illustrating a configuration of a server according to another embodiment of the present invention;

FIG. 3 is a block diagram illustrating a configuration of a user terminal apparatus according to an embodiment of the present invention;

FIGS. 4A and 4B are diagrams illustrating a method of filtering an application according to an embodiment of the present invention;

FIG. 5 is a diagram illustrating a method of recommending a core application according to an embodiment of the present invention;

FIG. 6 is a diagram illustrating a configuration of a service providing system according to an embodiment of the present invention;

FIGS. 7A to 7C are diagrams illustrating a User Interface (UI) providing format according to an embodiment of the present invention;

FIGS. 8A to 8C are diagrams illustrating an UI providing format according to another embodiment of the present invention;

FIGS. 9A and 9B are diagrams illustrating a kind of data according to an embodiment of the present invention;

FIG. 10 is a flow chart illustrating a method of providing service according to an embodiment of the present invention; and

FIG. 11 is a flow chart illustrating a method of controlling a user terminal apparatus according to an embodiment of the present invention.

### DETAILED DESCRIPTION OF THE EMBODIMENTS OF THE PRESENT INVENTION

Hereinafter, embodiments of the present invention will be described in greater detail with reference to the accompanying drawings.

In the following description, same or similar reference numerals are used for the same or similar elements when they are depicted in different drawings. The matters described in the description, such as detailed construction and elements, are provided to assist in a comprehensive understanding of the embodiments of the present invention. Thus, it is apparent that the embodiments of the present invention can be carried out without those specifically defined matters. Also, well-known functions or elements art are not described in detail to avoid obscuring the embodiments of the present invention with unnecessary detail.

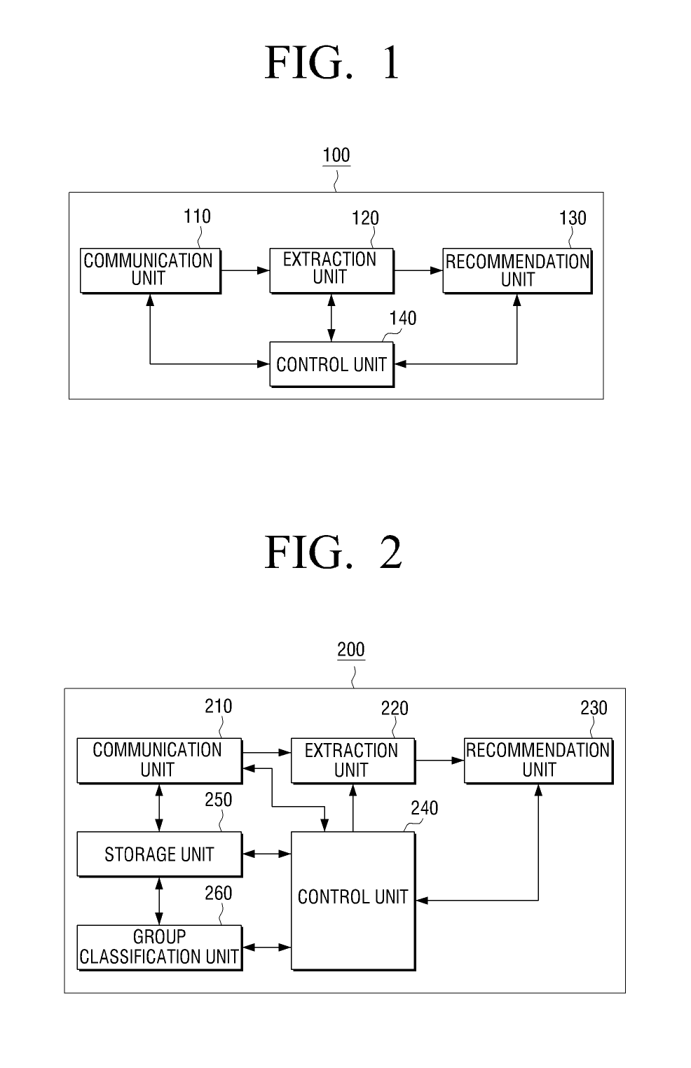

FIG. 1 is a block diagram illustrating a configuration of a server according to an embodiment of the present invention.

Referring to FIG. 1, the server includes a communication unit 110, an extraction unit 120, a recommendation unit 130 and a control unit 140.

The communication unit 110 may perform data communication with a plurality of user terminals and receive a content list in which a plurality of content is packaged from the plurality of user terminals. The content may be implemented as a music content type, a moving image content type, or a smart phone application type. Hereinafter, the smart phone application content type will be described as an example.

The content list which is an application list may be a list in a form that a user for each of the plurality of user terminals freely packages applications for his/her own entertainment or convenience.

Specifically, the application list may include a packaging title, description and a keyword.

For example, the user may make a packaging title, description, and a keyword and select applications to be packaged among applications installed in the user terminal. Alternatively, the user may select an application to be packaged among applications installed in the user terminal and make a packaging title, description and a keyword, thereby configuring the application packaging.

For example, the packaging may be configured as a structure where Package=title+description+{app ID, app ID, app ID}+keywords

A specific method of packaging application will be described below.

The extraction unit 120 extracts a core application by considering a packaging frequency of an application included in at least one list uploaded from the plurality of user terminals.

Specifically, an application which is frequently packaged among the packaged applications is extracted as the core application. For example, if a specific map application is frequently included in a packaging among many map applications and performances well, it may be decided that the specific map application is a core application.

The recommendation unit 130 recommends a predetermined application to a user.

The control unit 140 controls to recommend an extracted core application if requested by a user. For example, the control unit 140 may preferentially recommend the extracted application among the applications classified for the predetermined subject as the core application to the user of the user terminal apparatus.

Further, the control unit 140 may select a core user (for example, designated as an expert) by considering the number of uploads of the core application and give a predetermined reward to the selected core user. For example, the control unit 140 may give a coupon to the selected core user or grant qualifications to the selected core user.

FIG. 2 is a block diagram illustrating a configuration of a server according to another embodiment of the present invention.

Referring to FIG. 2, the server 100 includes a communication unit 210, an extraction unit 220, a recommendation unit 230, a control unit 240, a storage unit 250 and a group classification unit 260. The description of the configuration elements of FIG. 2 similar to the configuration elements of FIG. 1 will be omitted.

The communication unit 210 may perform data communication with a plurality of user terminals and receive an application list in a form in which a plurality of applications are packaged from the plurality of user terminals.

Here, the application list may be a list in a form in which a user for each of the plurality of user terminals freely packages applications for his/her own entertainment or convenience.

Specifically, the application list may include a packaging title, description or a keyword for packaging.

Further, the communication unit 210 may provide an application download path to the plurality of user terminals.

The extraction unit 220 extracts a core application by considering a packaging frequency of each application included in at least one list uploaded from the plurality of user terminals.

The recommendation unit 230 functions to recommend a predetermined application to a user. The recommendation unit 230 may consider an application packaging frequency analyzed as supplement data for grouping by a Collaborative Filtering (CF) method to be described below.

The control unit 240 controls the recommendation of the extracted core application if requested by a user. For example, the control unit 240 may preferentially recommend an application extracted as a core application among applications classified according to a predetermined subject to the user.

Further, the control unit 240 may select a core user (for example, designated as an expert) by considering the number of uploads of the core applications and give a predetermined reward to the selected core user. For example, the control unit 140 may give a coupon to the selected core user or grant predetermined qualification to the core user.

Further, the control unit 240 may control the recommendation unit 230 to recommend the core application using the core application/user data extracted by the extraction unit 220 as supplement data for grouping in CF to be described below.

The storage unit 250 may store usage data for applications downloaded through the communication unit 210. Here, the usage data for the downloaded application may be stored in a log data format. Specifically, the log data is divided into user information for each application (or base information) and application usage information and is stored in the storage unit 250.

Here, the control unit 240 may control to collect the usage data, on which recommendations will be based, that is, the user information (age, gender, country of a user, or the like) and the application usage information (execution time, installation/deletion information, or the like) with user consent.

Further, the usage data may be manually transferred at a user desired time. Alternatively, the usage data may be transferred based on a preset event such as application installation/deletion. Usage data makes it possible to recommend popular application for each country/gender/age through the transferred usage data and analyze a lifetime of an application through users' average execution time and installation/deletion information. Further, applications having previously deleted history may not be recommended, using the deletion information.

The group classification unit 260 may perform CF based on application usage data stored in the storage unit 250.

Specifically, the group classification unit 260 may classify groups into a user-based group or an item-based group. Here, the user-based group classification may include classifying groups for users having similar application download and usage history and analyzing a favorite application for each group. The item-based group classification may include classifying groups for associated applications purchased together and analyzing application association for each group. The group classification unit 260 determines whether or not a user belongs to which group, or an application belongs to which group, based on the user group and the application group analyzed through a CF. Further, the analyzed data may be stored in the storage unit 250 to supplement the usage data. Further, it is possible to recommend a popular application for each user group/application group.

The control unit 240 may control to extract a favorite application for each classified group and d extract a core application based on the favorite application for each group.

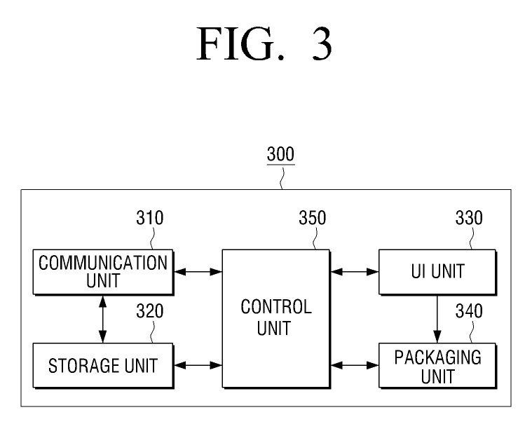

FIG. 3 is a block diagram illustrating a configuration of a user terminal apparatus according to an embodiment of the present invention.

Referring to FIG. 3, the user terminal apparatus 300 includes a communication unit 310, a storage unit 320, a user interface unit 330, a packaging unit 340 and a control unit 350.

The user interface apparatus 300 may be implemented by so called smart phone capable of downloading applications through a network and may be implanted by a network and various apparatus supporting a corresponding application program other than the smart phone.

The communication unit 310 provides a communication interface which downloads an application and log data for the application from a server (not shown).

The storage unit 320 is a storage medium which stores various programs required to operate the user terminal apparatus 300 and may be implemented by a memory, a hard disk drive (HDD), or the like.

In particular, the storage unit 320 may store a plurality of application downloaded through the communication unit 310 and usage data for each of the plurality of application. Here, the usage data may include at least one of user information for a corresponding application and usage information for the corresponding application.

Specifically, the user information may include an age, gender, and country of a user, and the like and the application usage information may include an execution time, installation/deletion information, or the like. The usage data may be collected with user consent.

The user interface unit 330 may select a plurality of applications to provide a user interface (UI) for packaging. Thereby, the user terminal apparatus 300 may further include an UI processing unit (not shown) for processing the UI provided through the user interface unit 330.

Here, the UI processing unit (not shown) may perform a process such as two-dimensional (2D)/three-dimensional (3D) conversion of an UI factor, transparency, color, size, type and position adjustment, highlight, and animation effect under the control of the control unit 350.

Further, the user interface unit 330 may be implemented by a touch pad having a display function, or a key pad or touch screen type including various function keys, numeric keys, special keys, character keys, or the like.

The packaging unit 340 may package some applications among the plurality of applications stored in the storage unit 320 and generate an application list for the packaged applications.

For example, users for the user terminal apparatus 300 may package applications corresponding to a specific theme that the users prefer. For example, a package referred to as a dating manager may include an application for informing transportation information, application for informing a good restaurant, a camera application for photographing your date, or the like.

A package referred to as a homework helper may include an English dictionary application, a timer/alarm application, a Korean dictionary application, or the like. When the applications are packaged according to a theme and the packaged applications are provided to a server, a person understanding semantics can recommend applications without a complicated ontology configuration.

Further, users prefer to be the first to download and use popular applications (in particular, in the case of free applications) so that people can collect and package only popular applications.

The communication unit 310 may upload the at least one application list generated by the packaging unit 340 to a server according to the control of the control unit 350.

The control unit 350 may control to package a plurality of applications of the plurality of applications stored in the storage unit 320 selected through the UI provided from the UI unit 330.

Further, if the control unit 350 receives recommendation for the core application extracted by considering a packaging frequency for each application included in the at least one uploaded list from a server, the control unit 350 controls the UI unit 330 to display the core application and provide the core application to a user.

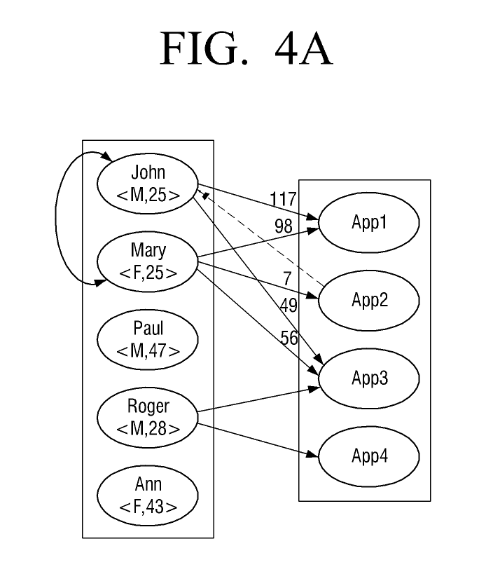

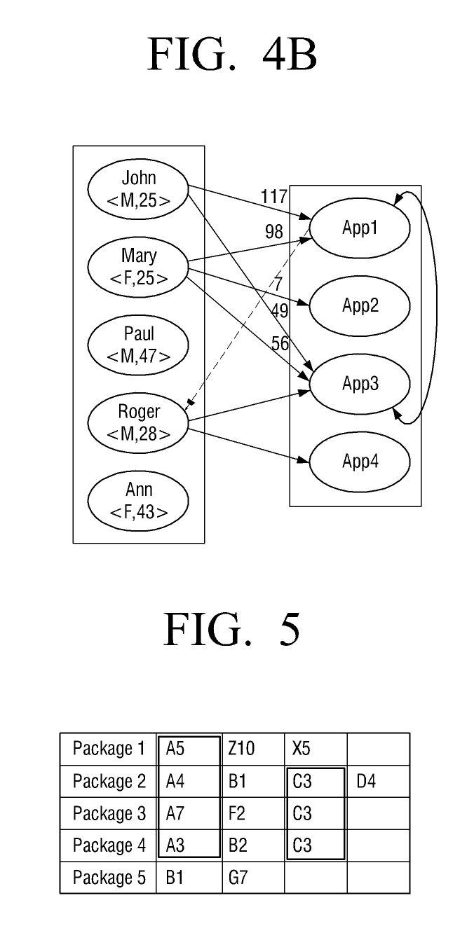

FIGS. 4A and 4B are diagrams illustrating a method of filtering applications according to an embodiment of the present invention.

The filtering method as shown in FIGS. 4A and 4B illustrates the above-mentioned CF method.

FIG. 4A is a diagram illustrating a user-based filtering method according to an embodiment of the present invention.

Referring to FIG. 4A, the user-based filtering method is a method of grouping users which use similar content and recommending content of a user from the group. When there is content that the users do not have among content mainly used by the users in the group, the content may be recommended.

FIG. 4B is a diagram illustrating an item-based filtering method according to an embodiment of the present invention.

Referring to FIG. 4B, the item-based filtering method is a method of grouping applications and recommending the applications. The item-based filtering method may recognize application association, which is based on the grouped applications and recommend the application based on the application association.

For example, when it is recognized that “Appl 1” and “Appl 3” are associated, “Appl 1” may be recommended to a user, Roger who has an application “Appl 3” but does not have an application “Appl 1”.

FIG. 5 is a diagram illustrating a method of recommending a core application according to an embodiment of the present invention.

Referring to FIG. 5, it is determined that an application “C3” is repeatedly packaged among applications belonging to some packages Package 1 to Package 5 and the application “C3” may be regarded as a core application.

On the other hand, when it is assumed that applications “A5”, “A4”, “A7” and “A3” belong to the same group (for example, the same category or the same application group), since it is determined that applications belonging to a corresponding group are frequently used for packaging, the corresponding group may be regarded as a core group.

Further, a user that uploads good packaging (for example, packaging including a core application) many times may be identified as a core user and designated as an expert, thereby leading packaging recommendations.

When the user is designated as an expert, that the user may receive a special qualification or a coupon.

The core application list extracted in the above-described embodiment of the present invention may be stored in the application usage data and use the application usage data as supplement data of CF. Thereby, a semantic factor determined by people is reinforced to the application group generated in a CF process so that it is possible to perform a more effective recommendation by supplementing CF data.

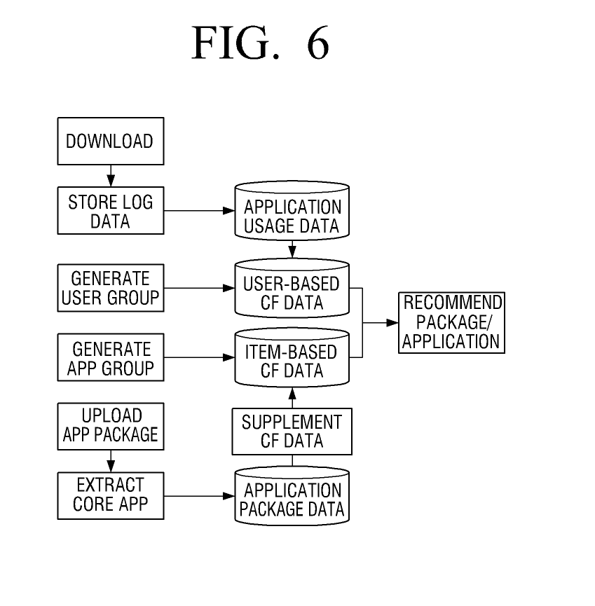

FIG. 6 is a diagram illustrating a configuration of a service providing system according to an embodiment of the present invention.

A configuration as shown in FIG. 6 illustrates operations of the servers 100 and 200 as shown in FIGS. 1 and 2 and the user terminal apparatus 300 as shown in FIG. 3. The detailed description of an overlapping portion will be omitted.

First, when an application is downloaded by the user terminal apparatus 300, log data for the downloaded application, that is, application usage data may be stored in “application usage data base (DB). Here, the application usage data may include user relation information including age, gender, and country information of a user, and the like and application usage relation information including an application execution time, installation/deletion information, and the like.

More specifically, the usage data transferred to the server may include app usage information such as “appID,[execTime, execFreq, execDay]+”, app installation/deletion information such as “appID,installDate, type, lifeTime”, profile information such as “country, ageGroup, gender”, and concern app identification (ID) information such as “appID”. Further, the information may be set to be transferred as “Default” or may be set to be transferred by “Request”.

The usage data stored in “application usage data DB” may be used for user-based filtering and item-based filtering and data for applications belonging to a user group and an application group generated by each of filtering may be stored in “user-based CF data DB” and “item-based CF data DF,” respectively.

Alternatively, a core application may be extracted from a packaging application list uploaded in the user terminal apparatus 300 and data for the core application may be stored in “application packaging data DB”.

Subsequently, data stored in “application packaging data DB” may be used for supplementing data stored in “user-based CF data DB” and “item-based CF data BD” and packaging or extracting the applications. That is, an application in which the number of application packaging and a favorite degree are reflected may be recommended as the core application.

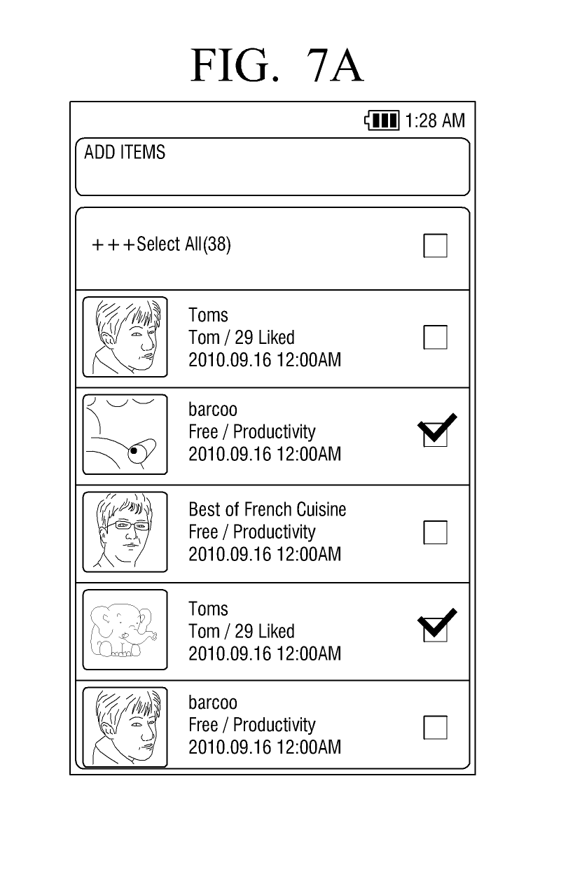

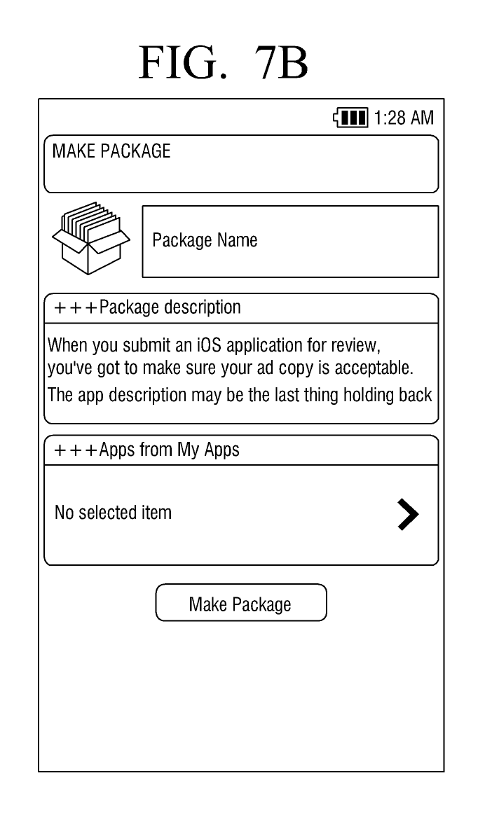

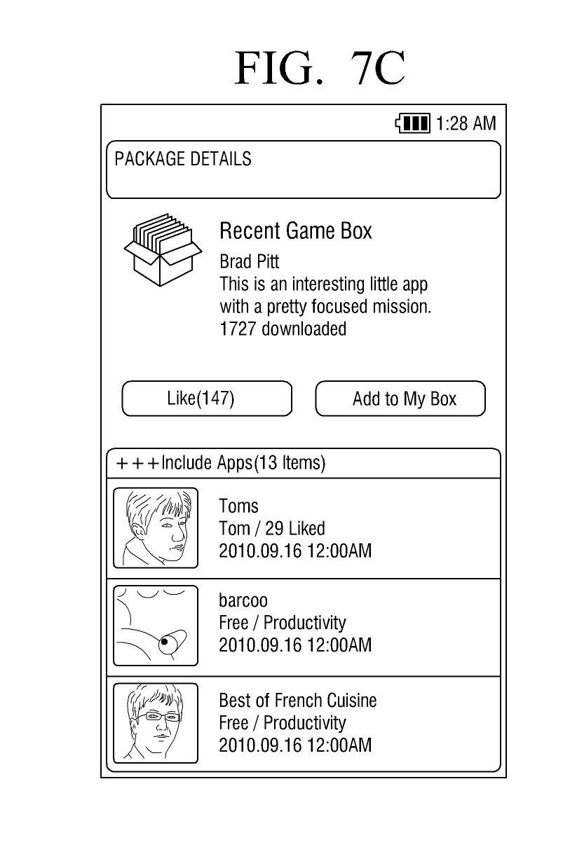

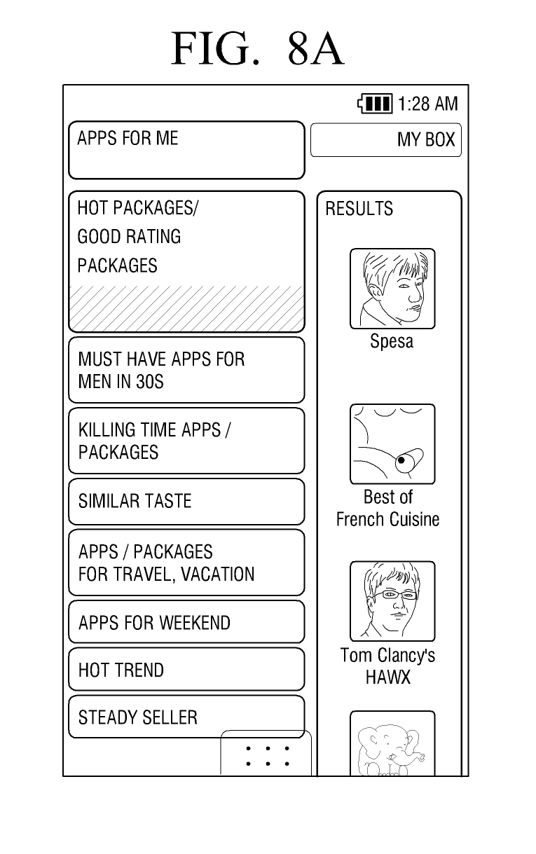

FIGS. 7A to 7C are diagrams illustrating a format of providing a UI according to an embodiment of the present invention.

Referring to FIG. 7A, a user may select an application “barcoo, Toms” to be packaged through a UI screen of the user terminal apparatus (for example, “ADD ITEMS” menu).

Referring to FIG. 7B, a user may set a package title through a UI screen (for example, “MAKE PACKAGE”) and input description for the package title, thereby generating application packaging. Further, an application belonging to packaging through “Apps from My Apps” menu may be displayed and checked by the user as shown in FIG. 7B.

Referring to FIG. 7C, a user may check application packaging information generated through a UI screen (PACKAGE DETAILS). As shown in FIG. 7C, the user may check application packaging details such as packaging title, description, application information constituting a packaging through the UI screen (PACKAGE DETAILS).

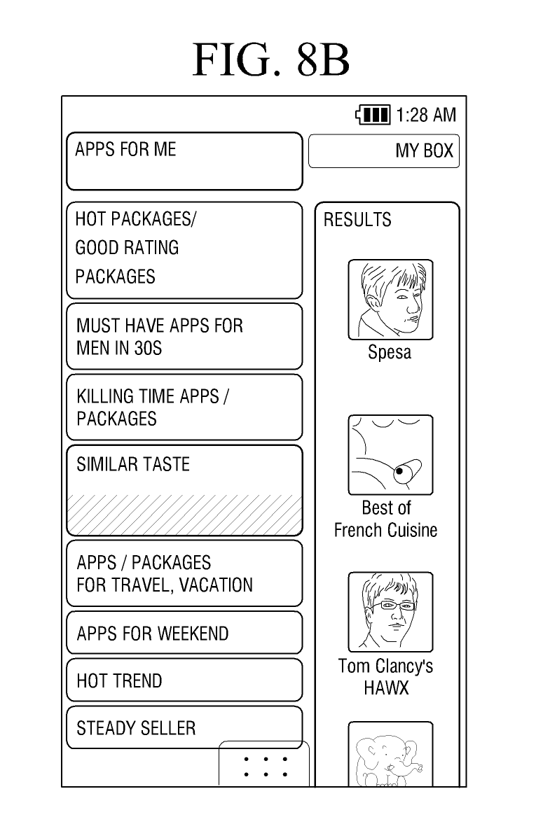

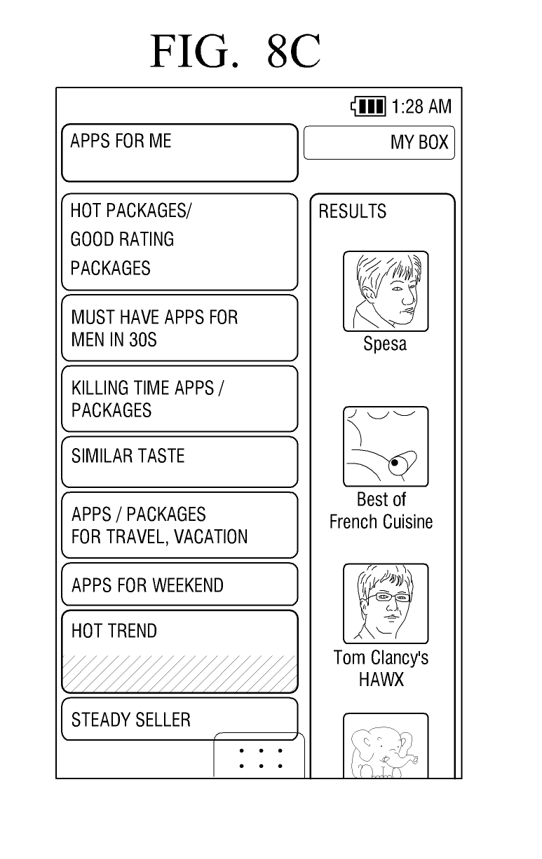

FIGS. 8A to 8C are diagrams illustrating a format of providing a UI according to another embodiment of the present invention.

Referring to FIGS. 8A to 8C, a user may receive a recommendation for an application through a UI screen (APPS FOR ME). Specifically, various application categories may be provided to the user and a desired category may be selected by the user from the various application categories.

FIG. 8A illustrates the state of displaying the recommended application to a “RESULTS” region when the user selects “HOT PACKAGES/GOOD RATING PACKAGES” category.

FIG. 8B illustrates the state of displaying the recommended application to the “RESULTS” region when the user selects a “SIMILAR TASTE” category.

FIG. 8C illustrates the state of displaying the recommended application to the “RESULTS” region when the user selects “HOT TREND” category.

Applications recommended in FIGS. 8A to 8C may be applications extracted as core applications among applications uploaded to a server through application packaging processes as shown in FIGS. 7A to 7C.

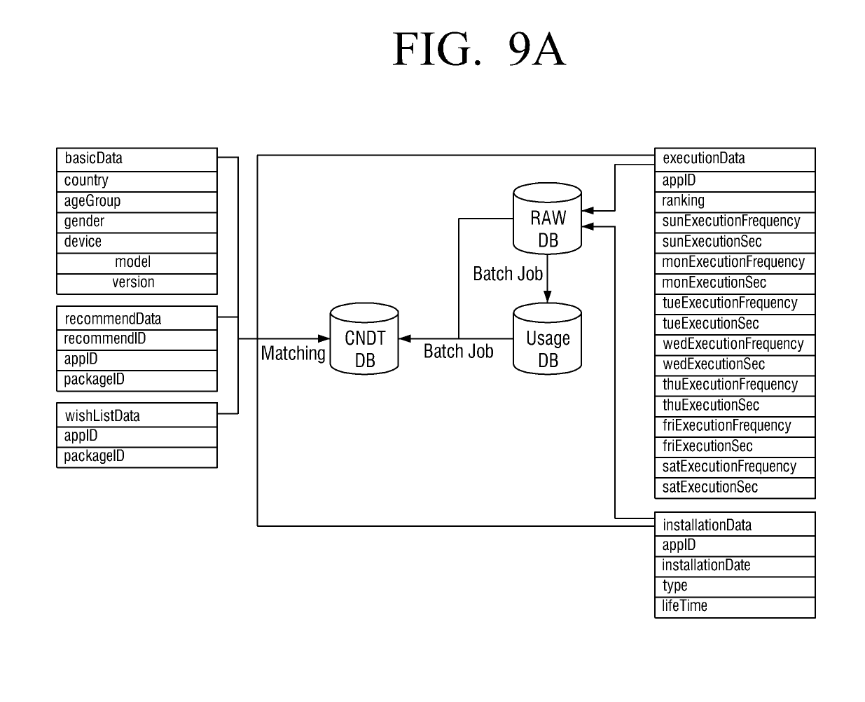

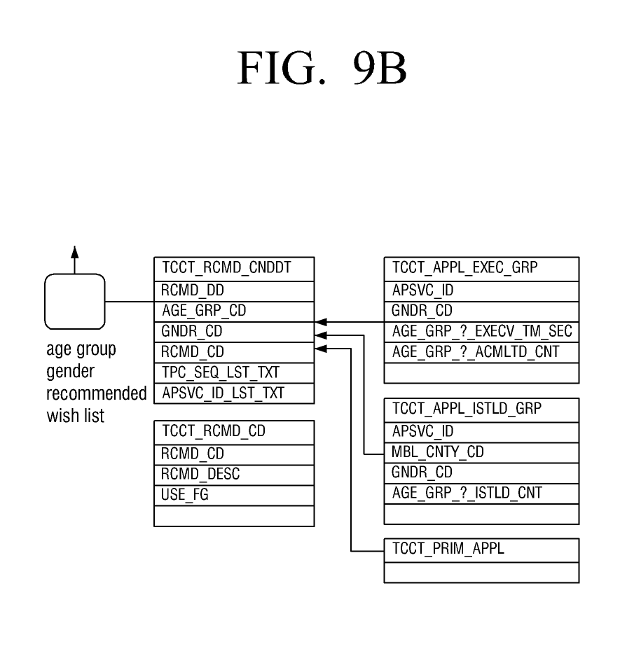

FIGS. 9A to 9C are diagrams illustrating a kind of data according to an embodiment of the present invention.

Referring to FIG. 9A, execution data “executionData” and installation data “installationData” corresponding to the downloaded application may be randomly extracted and stored in “RAW DB.” Here, the execution data may include application ID, priority, an execution day, an execution time, or the like. Further, the installation data may include an application ID, an installation date, a type, a valid data, or the like.

Subsequently, usage data used for application recommendation may be extracted from data stored in “RAW DB” through a batch task 1 and stored in “Usage DB.”

Further, data for a candidate application may be extracted from data stored in “Usage DB” through the batch task 2 and a matching task 3 and stored in “CNDT DB.” Here, the data stored in “Usage DB” may be extracted through a matching task with base data, recommendation data, wish list data, or the like as a candidate.

Referring to FIG. 9B, a process of extracting data required to extract a core application among various pieces of data stored in “Usage DB” can be checked through the batch task, followed by storing the extracted data in “CNDT DB” and using the data stored in “CNDT DB” to extract the core application.

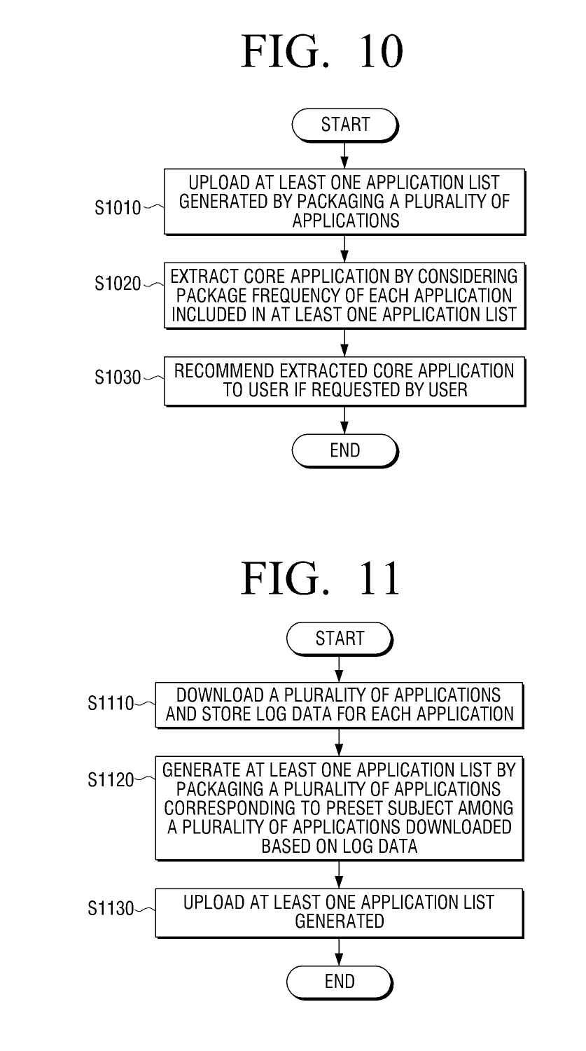

FIG. 10 is a flow chart illustrating a method of providing service of a server according to an embodiment of the present invention.

According to the method in FIG. 10, the server uploads at least one application list generated packaging a plurality of applications in step S1010.

Subsequently, the server extracts a core application by considering a packaging frequency for each application included in the at least one application list uploaded in step S1020.

In step S1030, the server may recommend the core application extracted in step S1020 if requested by the user.

The application list may include at least one of a packaging title, description and a keyword.

Further, the server may select a core user by considering the number of uploads of the core application.

The server may give a coupon to the user or grant predetermined qualifications to the user.

The server may store the usage data for the plurality of application downloaded, classify the plurality of application downloaded into user-based groups based on the usage data, and use the user-based groups to extract the core application. Specifically, the server may extract a favorite application for each classified group and recommend the core application based on the extracted favorite application for each the extracted group.

Alternatively, the server may store the usage data for each of the plurality of applications downloaded, classify the plurality of downloaded applications into application-based groups based on the usage data, and use the application-based groups to extract the core application. Specifically, the server may analyze application association for each classified group and recommend the core application based on the application association for each group.

Here, the usage data may include at least one of user information for a corresponding application and usage information for the corresponding application.

FIG. 11 is a flowchart illustrating a method of controlling a user terminal apparatus according to another aspect of the present invention.

According to a method of controlling a user terminal apparatus as shown in FIG. 11, first, the user terminal apparatus may download a plurality of applications and store usage data for each of the plurality of applications in step S1110.

Subsequently, the user terminal apparatus may package a plurality of applications corresponding to a preset subject among the plurality of applications downloaded based on stored usage data and generate at least one application list in step S1120.

Hereafter, the user terminal apparatus may upload the at least one application list generated to a server in step S1130.

The user terminal apparatus may receive a recommendation for the extracted core application by considering a packaging frequency of each application included in the at least one application list from a server and display the recommended core application. That is, the server may analyze a packaging application list uploaded, extract the core application based on an analyzing result, and use the core application to recommend an application for a user terminal apparatus.

Here, the usage data may include at least one of user information for a corresponding application and usage information for the corresponding application.

Thus, application association is not determined through simple category classification or an uncertain star rating, but the association between applications is analyzed based on a user's direct packaging to provide accurate recommendation.

While the present invention has been shown and described with reference to certain embodiments thereof, it will be understood by those skilled in the art that various changes in form and detail may be made therein without departing from the spirit and scope of the present invention as defined by the appended claims.

What is claimed is:

1. A method of providing service, comprising:
generating at least one content list by packaging a plurality of content being uploaded;
extracting a core content by considering a packaging frequency for each content included in the at least one content list; and
recommending an extracted core content to a user if requested by a user.

2. The method as claimed in claim 1, further comprising:
storing usage data for each of the plurality of content downloaded;
classifying the plurality of content downloaded into user-based groups based on the usage data; and
extracting a favorite content for each classified group,
wherein recommending the extracted core content to the user includes recommending the core content to the user based on the favorite content for each group.

3. The method as claimed in claim 1, further comprising:
storing usage data for each of the plurality of content downloaded;
classifying the plurality of content downloaded into content-based groups based on the usage data; and
analyzing content association for each classified group,
wherein recommending the extracted core content to the user includes recommending the core content based on the content association for group.

4. The method as claimed in claim 2, wherein the usage data includes at least one of user information for a corresponding content and usage information for the corresponding content.

5. The method as claimed in claim 1, wherein the content list includes at least one of a packaging title, description and a keyword

6. The method as claimed in claim 1, wherein the content includes an application.

7. The method as claimed in claim 1, further comprising:
selecting a core user by considering the number of uploads of the core content; and
giving a coupon to a selected core user or granting predetermined qualification to the selected core user.

8. A method of controlling a user terminal apparatus, comprising:
downloading a plurality of content and storing usage data for each content;
generating at least one content list by packaging a plurality of content of the plurality of content downloaded corresponding to a preset subject based on the usage data; and
uploading the at least one content list generated to a server.

9. The method as claimed in claim 8, further comprising receiving recommendation for a core content extracted by considering a packaging frequency for each content included in the at least one content list from the server and displaying the core content recommended.

10. The method as claimed in claim 8, wherein the usage data includes at least one of user information for a corresponding content and usage information for the corresponding content.

11. A server, comprising:
a communication unit in which at least one content list generated by packaging a plurality of content is uploaded;
an extraction unit which extracts a core content by considering a packaging frequency of each content included in the at least one content list;
a recommendation unit which recommends a predetermined content to a user; and
a control unit which controls to recommend the core content extracted from the extraction unit if requested by the user.

12. The server as claimed in claim 11, further comprising:
a storage unit which stores usage data for each of the plurality of content downloaded; and
a group classification unit which classifies the plurality of content downloaded into user-based groups based on the usage data,
wherein the control unit controls to extract a favorite content for each classified group and recommend the core content based on the favorite content for each group.

13. The server as claimed in claim 11, further comprising:
a storage unit which stores usage data for each of the plurality of content downloaded; and
a group classification unit which classifies the plurality of content downloaded into content-based groups based on the usage data,
wherein the control unit controls to analyze content association for a classified group and recommend the core content based on the content association for each group.

14. The server as claimed in claim 12, wherein the usage data includes at least one of user information for a corresponding content and usage information for the corresponding content.

15. The server as claimed in claim 11, wherein the content list includes at least one of a packaging title, description and a keyword.

16. The server as claimed in claim 11, wherein the content includes an application.

17. The server as claimed in claim 11, wherein the control unit selects a core user by considering the number of uploads of the core content and gives a coupon to a selected core user or grants predetermined qualification to the selected core user.

18. A user terminal apparatus, comprising:
a storage unit which stores a plurality of content downloaded and usage data for each content;
a User Interface (UI) unit which provides a UI for selecting and packaging a plurality of content from the plurality of content downloaded;
a packaging unit which packages the plurality of content and generates at least one content list for the plurality of content packaged;
a communication unit which uploads the at least one content list generated to a server; and
a control unit which controls to package the plurality of content selected through the UI among the plurality of content stored in the storage unit.

19. The user terminal apparatus of claim 18, wherein the control unit controls to receive a recommendation for an extracted core content by considering the packaging frequency for each content included in the at least one content list uploaded from the server and display a recommended core content.

20. The user terminal apparatus of claim 18, wherein the usage data includes at least one of user information for a corresponding content and usage information for the corresponding content.
